(19) United States
(12) Patent Application Publication
(10) Pub. No.: US 2005/0060317 A1
(43) Pub. Date: Mar. 17, 2005

(54) Method and system for the specification of interface definitions and business rules and automatic generation of message validation and transformation software

(76) Inventors: Christopher Martin Lott, Morristown, NJ (US); Andrew J. Harned, Eatontown, NJ (US); Lisa A. Bahler, Basking Ridge, NJ (US); Josephine Micallef, Maplewood, NJ (US); Ashish Jain, Bridgewater, NJ (US); Francesco Caruso, Summit, NJ (US); Michael Long, Watertown, MA (US); Rabih M. Zbib, Valhalla, NY (US); Devasis Bassu, Flanders, NJ (US)

Correspondence Address: TELCORDIA TECHNOLOGIES, INC., ONE TELCORDIA DRIVE 5G116, PISCATAWAY, NJ, 08854-4157, US

(21) Appl. No.: 10/823,157

(22) Filed: Apr. 13, 2004

Related U.S. Application Data
(60) Provisional application No. 60/502,443, filed on Sep. 12, 2003.

(51) Int. Cl. G06F 17/30; G06F 17/00; G06F 17/21

(52) U.S. Cl. 707/10; 707/1; 707/100; 707/2; 707/203; 715/513; 715/532

(57) ABSTRACT

This system for generating message transformation and validation software uses interface definition documents as inputs. An interface definition consists of an internally consistent set of message definitions, data dictionary entries, transformation rules, and validation rules. A user-friendly graphical user interface provides the requirements engineer or other user with the ability to specify these documents. This graphical user interface is a structured table and rules editor that allows the requirements engineer to enter and validate interface definitions to ensure that the definitions meet certain predetermined requirements. The generation system takes the interface definition documents as input and generates various software artifacts to transform and validate messages. W3C XML schemas are generated from an interface definition for assistance with code development, for use as standards-compliant interface definition that can be reused and composed with other schemas, and for validating messages. Extensible Stylesheet Language Transform files are generated from an interface definition to transform and validate messages. These generated software artifacts for message transformation and validation may then be used to implement message-processing systems. One example where this software was deployed is a wireless or local number portability service bureau that permits portability requests to pass from one telecommunications entity to another. The graphical user interface also enables the user to compare interface definitions, generate schema artifacts, generate transformation and validation artifacts, generate test cases, generate message indices, and generate documentation for distribution and review (formats include Microsoft Word, rich-text format, and HTML). Preexisting requirements documents may be converted for use in the present system by parsing and translating the preexisting documents into the interface definition documents. After this conversion process, information that could not be parsed and translated is referred to the requirements engineer or other user, who reenters the information using the structured table and rules editor.

This application claims the benefit of U.S. Provisional Application No. 60/502,443, filed Sep. 12, 2003, incorporated herein in its entirety.

### FIELD OF THE INVENTION

The present invention relates to a method and system for improving the requirements engineering process. More specifically, the present invention relates to a method and system for the creation of rules documents and/or interface specifications and the automated generation of computer-implemented message transformation and/or validation software based on those business rules and interface definitions. Such software is used to provide services that transform message structures from one format to another and also validate messages based on certain specified rules and specifications. An example of such a service would be the facilitation of exchange of messages among different parties in the telecom, financial services, or health care arenas.

### BACKGROUND

Businesses transact business with other businesses through the exchange of various order forms and other documents. More and more of these documents are electronic, although many are based on previously used paper forms. Such forms can be thought of as an interface to a specific business for the purpose of requesting the business to perform a specific activity. An interface specification is used to define this interface in a uniform manner so that messages, such as service orders, can be validated against the specification for that type of order. If the message or order meets the interface specification then the message or order can be processed. If the message or order does not meet the interface specification, the message or order can be rejected and an error message can be returned to the submitting party.

An electronic clearinghouse is an entity that connects multiple trading partners. One such clearinghouse is used in the telecommunications area to connect competitive local exchange carriers (CLECs) with the incumbent local exchange carriers (ILECs). The CLECs transmit information about their customers and orders to the wholesale telecom suppliers, the ILECs. The information passed between trading partners uses intricately structured messages which may be specified in electronic data interchange (EDI) format, eXtensible Markup Language (XML) format, or Flexible Computer Interface (FCIF) format. Various ILECs may have differing requirements as to the format, structure and content of the messages. The CLECs engage the electronic clearinghouse to ensure that their messages comply with the requirements of the specific ILEC to which the message is being forwarded. Otherwise, the message could be rejected, resulting in a delay in processing the order. Rejected messages result in monetary loss, not just delay, because ILEC's charge CLEC's for each order submission, whether successful or not.

A similar clearinghouse is used to implement the federally mandated wireless and wireline number portability. Telecommunication service subscribers can request to transfer their current wireless or wireline phone number to another service provider and/or type of service. The new service provider generates a request to transfer a subscriber and the subscriber's number from the old provider. Service providers are required to submit requests in accordance with the Wireless Intercarrier Interface Specification (WICIS). Even if the requests conform with WICIS they may still need to be transformed from one carrier's format to another in order to be implemented. Additionally, the data in the messages must be validated so that the proper information is sent from the originating service provider in order to avoid delays.

Traditionally, a clearinghouse has been specified in part by requirements engineers who wrote requirements documents, i.e., collections of interface (message) specifications and/or business rules in a word processing format, most likely in Microsoft® Word® format. Software developers would then take the requirements document providing the message specification (business rules) and write software that tests the message for conformance to the specification.

An individual ELEC might accept thirty or more different messages, each requiring more than 200 pages to specify. Because thousands of pages of interface specifications and requirements rules need to be written, multiple requirements engineers are utilized, resulting in tremendous variation between various specification or requirements documents. Variations, inconsistencies and errors while translating the interface specifications and requirements rules to software that implements the specifications and rules result in software failures and faults contributing to a high error rate, software fixes, and eroded profits for the clearinghouse or other service.

The prior approach for creating interface specifications and generating the translation and validation software suffered from several problems. First, the word processing documents included typographical errors, duplicate information, malformed statements (such as unmatched parentheses), errors due to ambiguity and different styles, and missing Boolean connectors. Information from one column was often unnecessarily repeated in other columns. Also, documents very often expressed dependencies upon information which was to have been defined in other documents, but was not. The vocabulary in the word processing environment was not standardized and conflicting definitions for basic terms often were found across a set of documents or even in the same document. Further, aside from the issue of errors in the specifications themselves, the act of manually converting those specifications into translation and validation software is inherently error-prone. Different words often meant different things to different requirements engineers who wrote the requirements documents

Use of special requirements languages requires extensive training on the part of the requirements engineers who are not typically computer programmers. Likewise standardized business document description languages such as the Universal Business Language (UBL) may be used to describe documents. UBL does not provide a graphical user interface, which can constrain the inputs of a requirements engineer. Additionally, UBL does not enable one to perform message or document transformations and validations or to generate such software automatically.

Business rules and the message definitions that define interface specifications also change rapidly, requiring changes either in the requirements documents and/or the testing and validation software generated from the requirements documents. The prior system forced a requirements engineer to change the requirements document and then have a programmer make changes to the software that performed the message transformations and validations.

Therefore, it is desirable to have a system and method for the creation of interface specifications using a structured environment not requiring extensive training of existing personnel.

Furthermore, it is desirable to have a system and method for using the interface specifications and rule documents to automatically generate software that implements transformation and validation rules, that can be expressed in part as W3C XML schema, or XSLT, rather than using human developers to manually code the software.

Additionally, it is desirable to have a method and system that is more responsive to the needs of the customer, enabling expeditious implementation of interface specification and business rule changes.

Automated generation of the business rule code eliminates a human touch point in the development cycle, thereby eliminating cost and errors errors that could be introduced during a manual coding process.

### SUMMARY

In the system and method of the present invention, interface specifications and business document or message rules and data transformation requirements are created using a structured editing tool. Interfaces can be specified using tables that define message definitions and data dictionaries. These message definition and data dictionary tables are then used to automatically generate message validation and transformation software.

An automatic code generation module reads the interface specifications and business rules and generates message validation and/or transformation code. In a preferred embodiment this is accomplished by translating the interface specifications and business rules into Extensible Stylesheet Language Transform (XSLT) and/or W3C XML Schemas, which can be executed using any standard XML Schema validating parser and/or XSLT Transformation Engine. Running these XSLT scripts against the XML messages results in the business rules being applied (whether they are rules to validate or transform a message), the generation of errors if the business rules are violated, and a transformation of the input XML message into an output XML message using the transformation XSLT script. The schemas can also be used to generate the overall skeleton of the application code itself, through the use of common code generators, leading to a tighter coupling between the interface specification and its representation within application code. Additionally, validation and transformation software may be generated in the Ilog® Rule Language (IRL).

Structured table editors enable the system to constrain the inputs of the user and to validate data during the entry phase so as to eliminate the time and expense of correcting such errors downstream. The present invention provides a user-friendly graphical user interface or project manager with which the requirements engineer or other user can specify message definitions, business rules and data dictionary entries. The project manager also enables the user to compare tables, validate and generate schema, automatically generate validation and transformation code, generate documentation and generate test cases.

### BRIEF DESCRIPTION OF THE DRAWINGS

FIG. 1 depicts a model for the Data Dictionary in a system in accordance with the present invention; and,

FIG. 2 depicts a model for the Message Definition in a system in accordance with the present invention.

FIG. 3 illustrates an exemplary rule validation and transformation generation system in accordance with the present invention;

FIG. 4 illustrates an example of a user interface for the rule validation function of a rule editor in accordance with the present invention;

FIG. 5 illustrates an example of a user interface for the element definition function of a rule editor in accordance with the present invention;

FIG. 6 illustrates an example of a user interface for specifying the length of a element in a rule editor in accordance with the present invention;

FIG. 7 illustrates an example of a user interface for specifying the two-dimensional Boolean condition Grid in a rule editor in accordance with the present invention;

FIG. 8 illustrates an example of a user interface for specifying mapping transformation rules in a rule editor in accordance with the present invention;

FIG. 9 illustrates an example of the tabular output of a rule editor in accordance with the present invention;

FIG. 10 depicts the process flow for the generation of validation and transformation rules from business rules input using a rule editor in accordance with the present invention;

FIG. 11 depicts the functional overview for the generation of validation and transformation code, test cases and documentation using the system of the present invention;

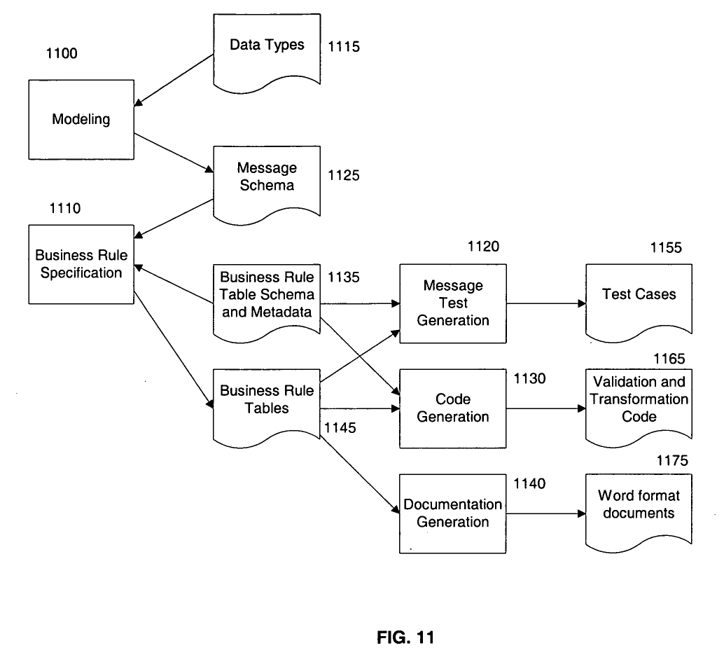

FIG. 12 depicts the detailed architecture for the project manager, which combines elements of the present invention into one user interface for manipulation of files for the generation of schema and business rule validation code.

FIG. 13 depicts the process for the implementation of the present invention in which a project manager is used to develop an interface specification without the use of external reference schema.

FIG. 14 depicts the process for the implementation of the present invention in which a project manager is used to develop an interface specification using external reference schema.

### DETAILED DESCRIPTION OF THE DRAWINGS

The present invention provides a system and method for creating interface specifications and business rule requirements documents that can then be used to automatically generate message translation and validation software. The message validation software can determine if messages are in compliance with a set of rules. The message transformation software can be used to change a message from one format to another. An example of this is the changing of a message from a format used and recognized by service provider A to a format used and recognized by service provider B. Validation is the process of determining if a message contains the necessary and proper data in the necessary fields for a valid message. An example of a business rule that involves validation is the checking of a telephone number supplied in a message to determine if it conforms with the North American Numbering Plan format of “NPA-XXX-XXXX”. An additional example of a validation would be verification that a query about residential telephone service availability contains an ADDRESS aggregate including the elements StreetNumber, ZipCode and StateID.

Translation and validation is accomplished by first specifying a set of interface definitions and requirements documents, i.e, business rules for the messages of a given service provider. Requirements documents have traditionally been written using a word processing format such as Microsoft® Word software. Such word processing files had semi-structured tabular formats with the requirements for a message or underlying data dictionary captured in those formats. In the telecommunications environment for the ILEC/CLEC clearinghouse, a message sent by a CLEC to a clearinghouse would be represented in FCWF by a collection of fields called “tags”, which are embedded in an enclosing field called an “aggregate.” Aggregates can be nested several levels up to the root aggregate called a “form.” The requirements documents typically define how every incoming CLEC tag and its values are translated into the corresponding ILEC tag and values. The requirements also specify certain invalid combinations of various pieces of data that trigger the clearinghouse to return an appropriate error message back to the CLEC while valid orders are forwarded to the ILEC. In this application the term “element” is used to generically describe elements or tags. The term “group of elements” is used to generically describe a plurality of nested elements or tags.

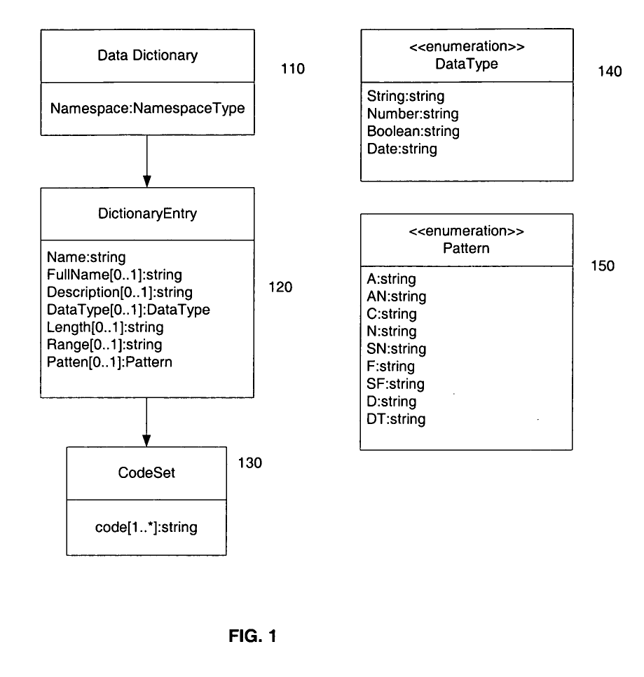

Element types are modeled in data dictionaries. The model of the Data Dictionary of one embodiment is set forth in FIG. 1. Each Data Dictionary will be associated with a particular namespace 110 and will contain a Dictionary Entry 120 for each element. The data dictionary is a dictionary of element types. For example, “TN10” and “TN12” could represent two types of the element “telephone number” having 10 digits and 12 digits respectively. Note that the term namespace refers here to a branch of the hierarchical naming structure and should not be confused with an XML namespace. The namespace 110 logically groups related model artifacts; concretely, it is mapped to the file system path under which the Data Dictionary will be found. All of the attributes in a Dictionary Entry 120 are optional, except for Name, which is a simple name relative to the namespace. The optional attributes can each appear at most once, and they are: Full Name, Description, Data Type, Pattern, Length, Range, Code Set and Path List.

In a data dictionary, attribute “Fullname” refers to the element's full name, which may be an expansion of an acronym used for the Name. Attribute “Description” refers to a natural language explanation of the element. Attribute “Data Type” 140 is the generic type family of the element and is selected from the set of “String,” “Number,” “Boolean” or “Date.” Attribute “Pattern” further refines the data type as shown in 150. The possible patterns are N (integer), SN (signed integer), F (decimal), SF (signed decimal), A (alphabetic), AN (alphanumeric), C (printable character), D (date in YYYYMMDD format) and DT (date/time in the YYYYMMDD.HHMMSS format). All of these patterns can be used in conjunction with the String data type, only the first four can be used with the Number data type, none with the Boolean data type, and only the last two with the Date data type. These patterns were chosen to cover types that commonly occur. The “Length” attribute specifies the lexical length of an element whose type is “String.” The “Range” attribute specifies the numeric range of a element whose data type is “Number.” In a Data Dictionary, “CodeSet” attribute 130 is an enumeration of possible values.

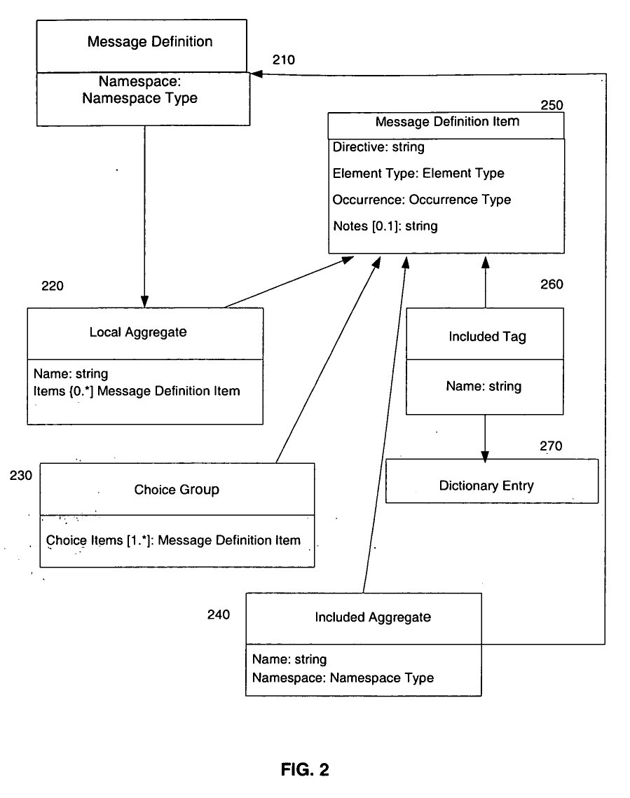

Referring to FIG. 2, a Message Definition 210, in contrast to an entry in the Data Dictionary, consists of a namespace and a root level aggregate or group of elements. A Local Aggregate 220 has a name and contains a set of Message Definition items 250. An element can be a local aggregate, choice group, included aggregate, or included tag, as depicted in FIG. 2. The “Directive” column provides the nesting level of the item within the message, as well as an indication of the interpretation of the element as a local aggregate, choice group, etc. The “Element Type” column provides the namespace-qualified type name for an included aggregate or tag. The “Occurrence” is the cardinality of the item. The “Notes” attribute includes additional text that may be relevant for the item (e.g., business rules). An Included Tag 260 in a message definition has an “Element Name”, as provided by a column with this label. The element's type may be defined within a data dictionary from an arbitrary namespace such as Dictionary Entry 270. An Included Aggregate 240 also has an “Element Name”, as provided by a column with this label. The element's type may be defined by a message definition from an arbitrary namespace. The ChoiceGroup 230 specifies a union structure, indicating that one of a set of choice items is to occur in that position in the message. A choice item may be an Element, Aggregate or Include, but not a nested ChoiceGroup.

The data dictionaries and message definitions that comprise a requirements document may be instantiated using various representations such as a tabular representation, Unified Modeling Language (UML) representation, a Java representation or an XML representation. For ease of use by the requirements engineer, a non-programming language representation is preferred, such as the tabular representation. The tabular representation of a Data Dictionary entry for an online pizza store (OPS) is depicted below in Table 1.

TABLE 1
Data Dictionary for namespace “OPS.FOOD”

| | |
|---|---|
| Name | Size |
| Data Type | String |
| Code Set | S, M, L |
| Name | Toppin |
| Data Type | String |
| Code Set | Pepperoni, Sausage, . . . |
| Name | Salad |
| Data Type | String |
| Code Set | House, Caesar |
| Name | Soup |
| Data Type | String |
| Code Set | Minestrone |

Table 2 depicts a tabular representation of a message definition in accordance with this embodiment of the present invention.

TABLE 2
Message Definition “OPS.FOOD.Items”

| Directive | Element Name | Element Type | Occ. |
|---|---|---|---|
| Begin Aggregate | Items< | | |
| [Level = 1] | | | |

| | | |
|---|---|---|
| Begin Aggregate | Pizza< | 0+ |
| [Level = 2] | | |

| | | | |
|---|---|---|---|
| Include Tag | Size | OPS.FOOD.Size | 1 |
| [Level = 3] | | | |
| Include Tag | Topping | OPS.FOOD.Topping | 1+ |
| [Level = 3] | | | |

| | | |
|---|---|---|
| End Aggregate | >Pizza | |
| [Level = 2] | | |
| Begin Aggregate | Pasta Special< | 0+ |
| [Level = 2] | | |
| Begin Choice | | 0-1 |
| [Level = 3] | | |

| | | | |
|---|---|---|---|
| Choice: Include Tag | Salad | OPS.FOOD.Salad | 1 |
| [Level = 3] | | | |
| Choice: Include Tag | Soup | OPS.FOOD.Soup | 1 Nil |
| [Level = 3] | | | |
| End Choice | | | |
| [Level = 3] | | | |

| | |
|---|---|
| End Aggregate | >Pasta Special |
| [Level = 2] | |

| | |
|---|---|
| End Aggregate | >Items |
| [Level = 1] | |

The online pizza store (OPS) has specified the requirements for the interface of an order entry system. Each order will contain customer information, information about the items ordered and optional delivery notes. The schemas are associated with three namespaces, OPS, and the namespaces CUSTOMER and FOOD, rooted under OPS. A Data Dictionary is defined for each namespace in this example, although a namespace could contain multiple dictionaries or even no dictionary. For the sake of brevity each namespace will contain just one message definition, although more could be contained in a functioning system. The data dictionaries for the FOOD, CUSTOMER and OPS namespaces are shown in Tables 1, 3 and 5 and the message definitions Items, Info and Order are shown in Tables 2, 4 and 6 respectively.

TABLE 3
Data Dictionary for namespace “OPS.CUSTOMER”

| | |
|---|---|
| Name | Name |
| Data Type | String |
| Length | 1-30 |
| Name | PhoneNumber |
| Data Type | String |
| Patten | N |
| Length | 7-10 |
| Name | StreetNumber |
| Data Type | String |
| Patten | N |
| Name | StreetName |
| Data Type | String |
| Pattern | A |
| Name | Town |
| Code Set | Our Town, NextTownOver |

TABLE 4
Message Definition “OPS.CUSTOMER.Info”

| Directive | Element Name | Element Type | Occ. |
|---|---|---|---|
| Begin Aggregate | Info< | | |
| [Level = 1] | | | |

| | | | |
|---|---|---|---|
| Include Tag | LastName | OPS.CUSTOMER.Name | 1 |
| [Level = 2] | | | |
| Include Tag | FirstName | OPS.CUSTOMER.Name | 0-1 |
| [Level = 2] | | | |
| Include Tag | PhoneNumber | OPS.CUSTOMER.PhoneNumber | 1 |
| [Level = 2] | | | |
| Begin Aggregate | Address< | | 0-1 |
| [Level = 2] | | | |

| | | | |
|---|---|---|---|
| Include Tag | StreetNumber | OPS.CUSTOMER.StreetNumber | 1 |
| [Level = 3] | | | |
| Include Tag | StreetName | OPS.CUSTOMER.StreetName | 1 |
| [Level = 3] | | | |
| Include Tag | Town | OPS.CUSTOMER.Town | 0-1 |
| [Level = 3] | | | |

| | |
|---|---|
| End Aggregate | >Address |
| [Level = 2] | |

| | |
|---|---|
| End Aggregate | >Info |
| [Level = 1] | |

TABLE 5
Data Dictionary for namespace “OPS”

| Name | SpecialInstructions |
|---|---|
| Data Type | String |
| Length | 1-512 |

TABLE 6
Message Definition “OPS.Order”

| Directive | Element Name | Element Type | Occ. |
|---|---|---|---|
| Begin | Order< | | |
| Aggregate | | | |
| [Level = 1] | | | |

| | | | |
|---|---|---|---|
| Include Tag | SpecialInstructions | OPS.SpecialInstructions | 1 |
| [Level = 2] | | | |
| Include | Info | OPS.CUSTOMER.Info | 1 |
| Aggregate | | | |
| [Level = 2] | | | |
| Include | Items | OPS.FOOD.Items | 1 |
| Aggregate | | | |
| [Level = 2] | | | |

| | |
|---|---|
| End | >Order |
| Aggregate | |
| [Level = 1] | |

The Online Pizza Store (“OPS”) will receive Order messages that are described by the Order message definition in the OPS namespace. This aggregate contains the element called SpecialInstructions that is specified in the Data Dictionary in the same namespace. The Order message definition also contains two included elements, Items and Info, that refer to message definitions from the other namespaces. This is shown by the “Include Aggregate” in the Level column. Each item within the Order aggregate is required, as specified by a cardinality of 1 in the occurrence columns.

The Customer message definition table models a customer aggregate and contains name and delivery information. The elements used in this aggregate are all defined in the OPS.CUSTOMER namespace, although they needn't be. The ‘Element Type’ column indicates the namespaces of the included types, and in this case, the types are all defined in OPS.CUSTOMER. The customer address is represented as a nested aggregate called Address, consisting of the elements: StreetNumber, StreetName and Town. Nested group of elements such as Address cannot be referenced directly from other message definitions since they are of local scope. Note that the customer's last and first names can both appear in the message, and that these elements, while they have different names, (LastName and FirstName, respectively), each refer to the same dictionary tag type, which is Name.

The Items aggregate contains the nested group of elements Pizza and PastaSpecial, which can each occur 0 or more times. When the Pizza aggregate occurs, it contains 1 Size item and 1 or more Topping items of elements defined in the OPS.FOOD namespace. The specification of PastaSpecial contains a ChoiceGroup, delimited by ‘Begin Choice’ and ‘End Choice’, that specifies a choice of items. The choice itself is optional and non-repeating. The cardinality of the choice group is in fact constrained by the model to be never more than 1, to prevent the creation of non-deterministic schemas. The means that the choice itself is made one time, but the model allows the cardinality of each choice item to be arbitrary. Next to the occurrence specifier for Soup is the word “Nil,” which is used to indicate that the Soup element may exist in the XML message with no content. In this case, no content for Soup means that the customer has ordered the soup of the day, so no further qualification is needed.

The dictionaries in this example contain elements whose data type is a String and which are additionally constrained. “Town” in the OPS.CUSTOMER Data Dictionary is an example of the use of Code Sets to constrain allowable values for an item based on the type (which defaults to String). “Name” and “PhoneNumber” show the use of Length to restrict the values for associated items to minimum and maximum lexical lengths. “StreetName” and “StreetNumber” show the restriction of the values for items based upon those types to being purely numeric or purely alphabetic.

Using the above example of the Message Definition and Data Dictionary it can be seen how these elements can be used in the creation of business rules. For example, the present system could be used to implement a rule such as “if the size of the pizza is ‘S’, no more than two toppings are allowed.” This rule can than be input using the rule editor described below.

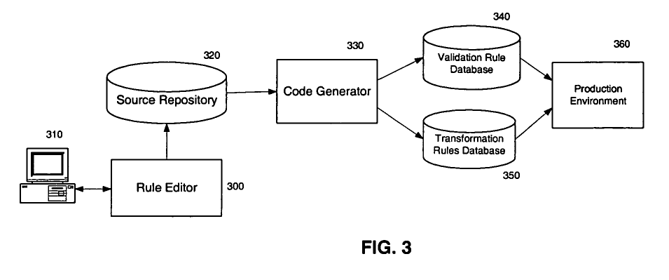

Referring to FIG. 3, one embodiment of a system in accordance with the present invention provides a requirements engineer a user terminal 310 that is in communication with a rule editor 300. Rule editor 300 is used by a requirements engineer to develop an interface specification comprising a set of Message Definitions and Data Dictionary entries and a set of rules regarding a message or set of messages. The output of rule editor 300 is an XML rule document that specifies the attributes of a message in XML, i.e., a message definition. The XML rule document is stored in source code repository 320 and is input to the automated code generator 330 from which XSLT for validations and XSLT for transformations, or schema (or Java code or ILR) are generated. This code is stored in one or more databases such as validation rules database 340 and transformation rules database 350. These rules may now be used in a production environment 360 in order to process incoming messages, i.e., transform or translate the message and/or validate the message. The various components of the system and the method of generating requirements documents, schemta and rules will now be described in greater detail.

W3C XML Schemas precisely define the structure of the XML messages comprising an interface. The schemas describe the hierarchical structure of the elements contained in XML messages, along with their: allowed occurrence counts. The schemas also provide a precise specification of the data dictionary types used within the messages, including such information as length of the data, possible values, and general format (alphabetic, numeric, etc.). Importantly, for enterprise-wide interface specification, with requirements referring to other requirements that are possibly authored by different organizations, the schemas include explicit references to other schemas, allowing messages to be specified by composition. Since the schema for a message depends upon the schema for the data dictionary, and usually upon the schemas for other message fragments, validation of the schemas will catch inconsistencies across these piece parts; such validation leads to consistency of interfaces across the enterprise.

The system and method of the present invention uses the existing extensible Markup Language (XML) to provide a highly structured representation of the requirements. XML documents are a plain-text file that can be stored on any personal computer and are easily sent by e-mail. XML files are readily understood by technical people and are managed by a conventional version control system. Libraries for manipulating XML documents are available for many programming languages. An XML-based repository of the requirements documents offers features of database technology such as queries and report generation.

XML documents may be transformed from one format to another using a language known as eXtensible Stylesheet Language Transformations (XSLT).

In the rule editor 300, normal XML is not presented for editing using a general-purpose text editor or even assisted editing using a general-purpose XML-editor. Such representations are not acceptable to the users of the business rule generation system of the present invention, i.e., the requirements engineers. Consequently, XML requirements data conforming to the defined XML schema is displayed as viewer friendly rendered HTML through the customized Extensible Stylesheet Language Transform (XSLT). This transform can be used by various tools and, thus, offers a human readable display of the requirements during editing, comparison and report generation.

A rule editor 300 is a main component of the present invention. One embodiment of a rule editor in accordance with the present invention is a graphical user interface (GUI) constructed to ensure proper input of requirements. In the rule editor 300 requirements are displayed in a highly readable HTML-based format after applying a suitable XSLT transformation. Unlike general-purpose XML editors, the rule editor 300 of the present invention shields the requirements engineers from both the raw XML and the underlying schema. The rule editor encourages the requirements engineer to follow a standard style of writing business rule information and validates the edited requirements using XML schema validation and extensive additional checks. For example, if the content of a data element is specified as alphabetic letters then the specified valid values must contain only alphabetic letters. If the length of a data element is constrained to a maximum of 5 then the specified valid values must be that length or shorter. Rule labels for a particular element must be unique. Certain patten/datatype/valid value combinations may not appear. Every expression must be well-formed with appropriate Boolean connectors among all sub-parts and with balanced parentheses around those sub-parts. In a list of error codes and explanations, the set of codes must be unique.

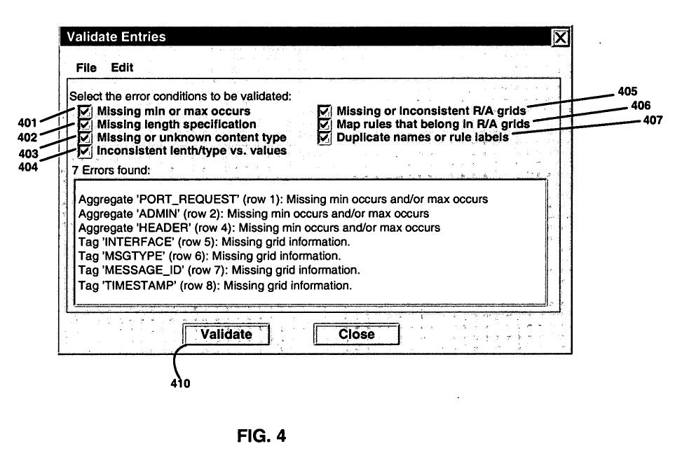

The rule editor ensures that all requirements documents are highly consistent and (to the extent possible) free of all the common problems of non-structured requirements documents. For example, in FIG. 4 the user interface for rule validation is depicted. The requirements engineer may select one of more of a plurality of error conditions to be validated 401-407. After clicking the “validate” button 410 the validation software scripts are executed and an error report is generated for the requirements engineer. The error report enables the requirements engineer to correct missing or improper data in one or more elements.

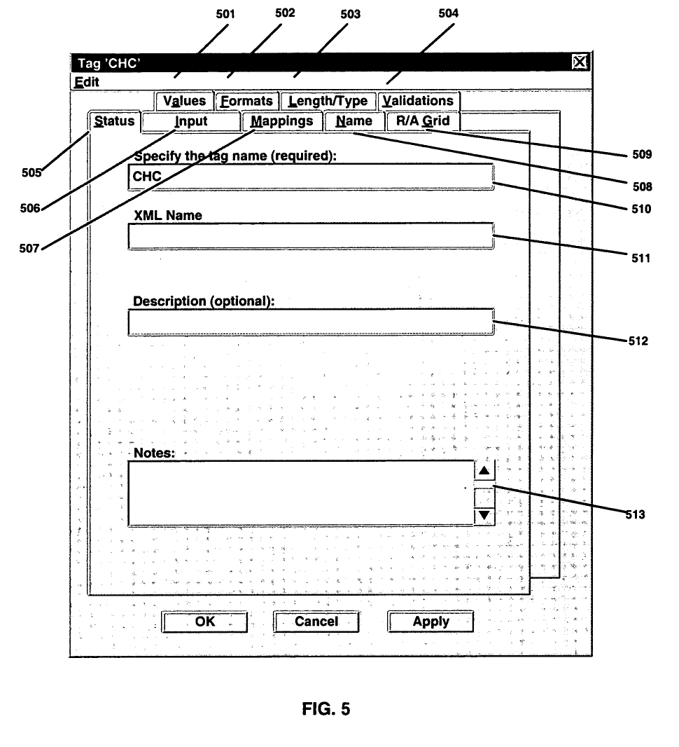

FIG. 5 shows an editing interface of the rule editor for the element “CHC”. A requirements engineer can edit specific parts of the requirements for this element: Values 501, Format 502, Length/Type 503, Validations 504, Status 505, Input 506, Mappings 507, Name 508, and the Boolean condition grid 509. In FIG. 5 the Name attribute of element “CHC” is being modified through entry of the element name in user interface box 510. An XML Name may also be specified through user interface box 511 as well as an optional description in box 512. The requirements engineer may specify notes about the element in box 513.

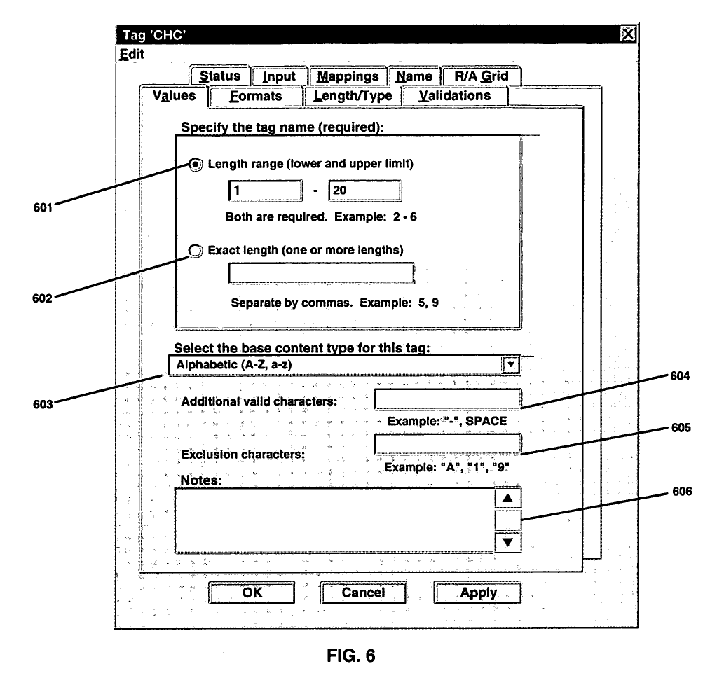

By selecting the “length/type” field the interface screen in FIG. 6 appears. The interface for this field of the “CHC” element limits and controls the input of the requirements engineer either to a length range 601 or one or more exact lengths 602 for element “CHC”. Drop down menu 603 provides the requirements engineer with the ability to select from a certain set of base type constraints such as alphabetical, alphanumeric, etc. User interface box 604 permits specification of additional valid characters whereas box 605 permits certain characters to be excluded. Box 606 enables the requirements engineer to make notes regarding the various requirements.

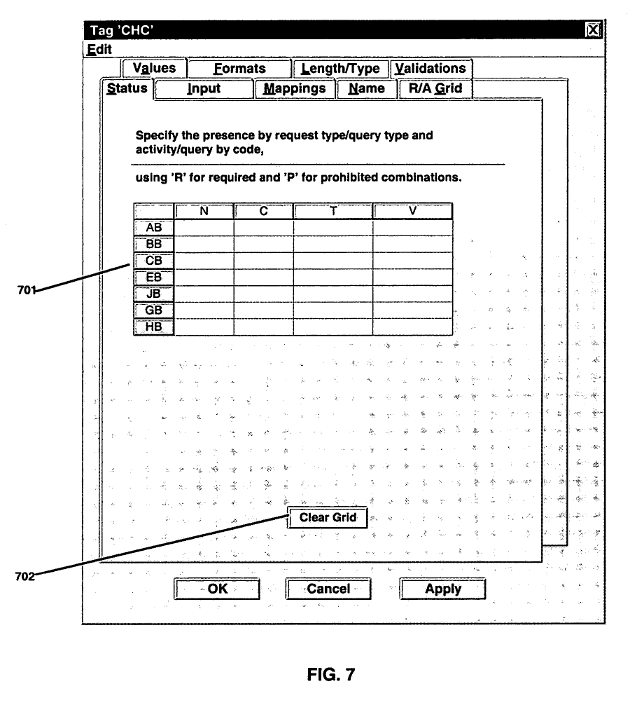

FIG. 7 shows the editing interface for the Boolean Condition grid 701. The grid is a compact way of specifying Boolean conditions for a specific combination of fields and values. The requirements engineer is limited to either using a “P” for a prohibited combination or “R” for a required combination thereby reducing input error in prior art systems. Button 702 enables the requirements engineer to clear the grid with one click.

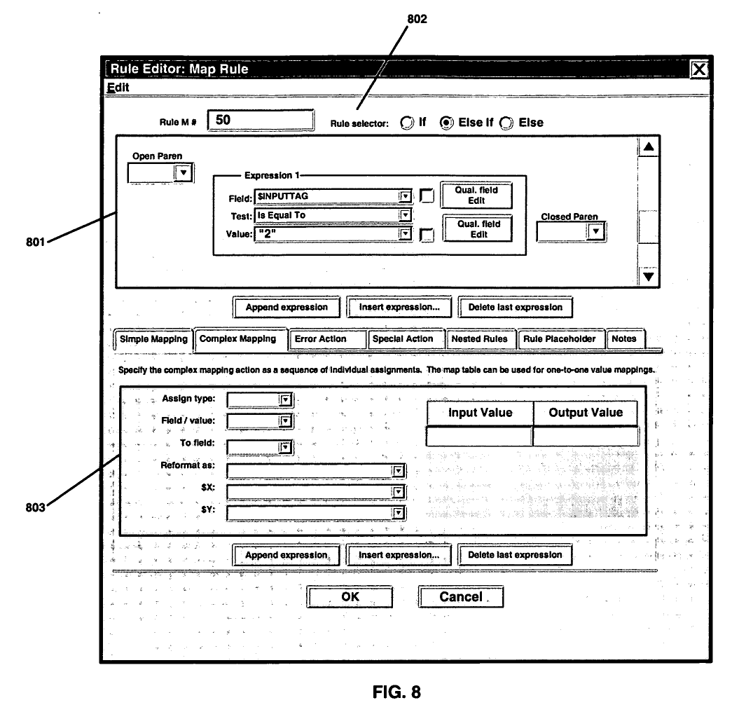

FIG. 8 shows an example of the user interface for the rule editor for generating a business rule using complex transformation. User interface box 801 enables the requirements engineer to input selected tests from a drop down menu of tests, to select a rule using radio buttons at rule selector 802 and to specify complex rule transformations at user interface box 803. This example shows the use of various constraints (i.e., radio buttons, drop down menus and rule formatting) on the requirements engineer in the structured rule editor.

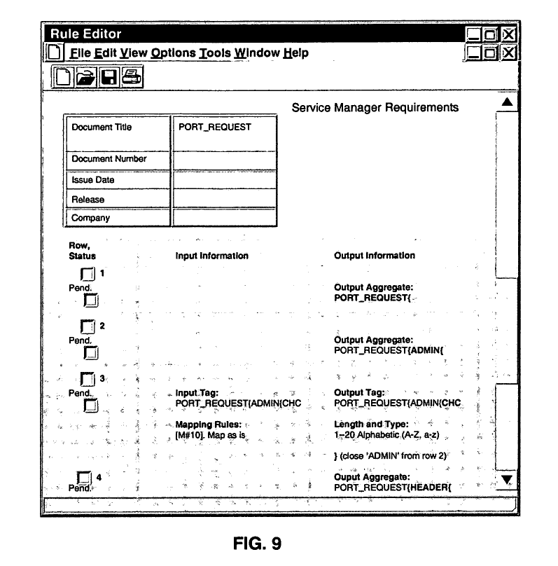

FIG. 9 shows an example screen shot of a requirements document in the rule editor. The editor is designed to provide the user with a view in a tabular format with a row for each entry.

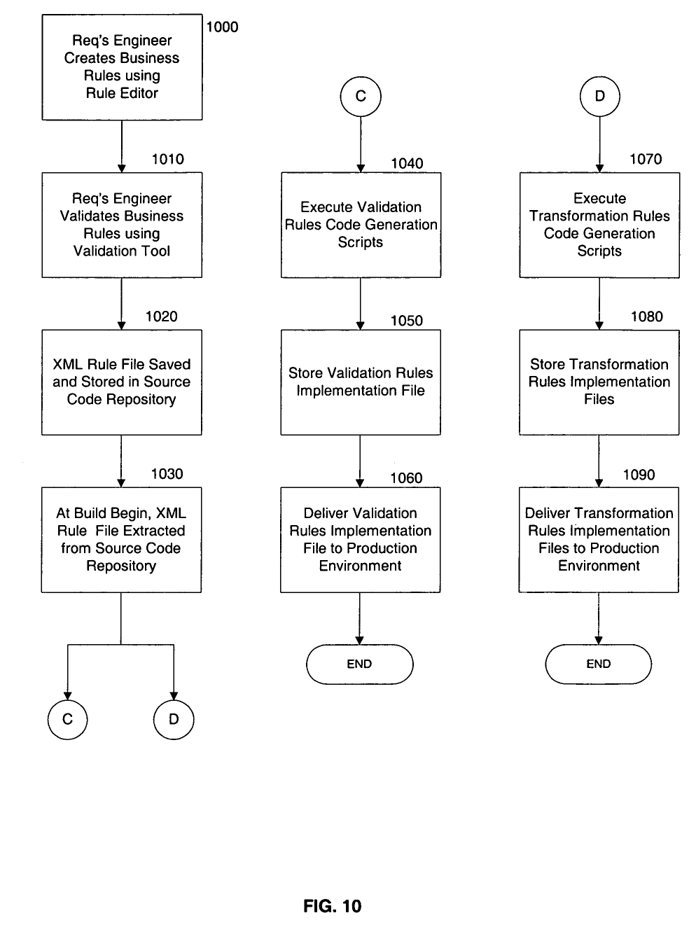

FIG. 10 depicts the process flow for developing validation and transformation rules for a production environment in accordance with the present invention. At the first step 1000, a requirements engineer creates business rules using the rule editor 300. Once input the business rules are validated at step 1010 by the requirements engineer using the validation tool that also forms part of the rule editor 1000. An XML rule file is then saved and stored in the controlled document repository 320 at step 1020. When the validation and transformation rules are needed in a production environment, the XML rule file is then extracted from the source code repository at step 1030 and forwarded to the code generator 330. The code generator 330 generates two different sets of rules: the validation rules and the transformation rules. At step 1040 the validation rules code generation scripts are execute to generate the validation rules implementation file or software. At step 1050 the validation rules implementation file are stored in validation rules database 340. When requested the validation rules are delivered to the production environment at step 1060 and can then be used to validate messages. At step 1070, the transformation rules code generation scripts are executed by the code generator 330 to generate the transformation rules implementation files or software. At step 1080, the transformation rules implementation files are stored in the transformation rules database 350. When requested the transformation rules are delivered to the production environment at step 1090 and can then be used to transform message from one format to another.

In one embodiment, the rule editor was built from Microsoft MSXML 4.0 and Internet Explorer 5.0+ using Microsoft VisualBasic version 6, although this can be implemented using many other programming languages. MSXML 4.0 includes an XML parser, a DOM library and XSLT functionality. This component is used to read, parse, and write XML files, to manipulate the XML document in memory and to transform the internal XML representation into viewable HTML using an XSLT stylesheet. The advantage of using XML is that it serves as a lightweight database. The basic system requirements for the an embodiment of an editor in accordance with the present invention are a personal computer operating Microsoft Windows 2000 (w/service pack 3) or Windows XP. Microsoft Internet Explorer 5.5 or later is preferable. Microsoft XML component version 4.0, Microsoft Data Access Components version 2.6 are also necessary in this embodiment. Of course, other computer hardware or software may be utilized to implement the same functions described herein.

Using Internet Explorer 4.0 or above as a component of the rule editor provides a web browser control that is used to display HTML documents and includes features such as scrolling, printing, searching, etc. It essentially functions as a web browser without the menu bar.

The structured rule editor tool makes it possible to eliminate redundancy as much as possible. For example, condition statements within some aggregate or element entries make reference to elements in that entry, such as a list of valid values.

The tool is developed for the particular domain of requirements and is enabled with features such as integrated editing and reuse of reference data files (which are XML in format for the preferred embodiment) with error messages among multiple forms, hooks to assemble and view textual contents of messages crossing the customer interfaces, short cuts to quickly specify common type of business rules, and different views of the requirements to facilitate working with large files.

A document comparison feature performs intelligent comparison of documents based on the table structure and generates reports that pinpoint the changes. This comparison tool is embedded in the structured rule editor. Highly customized change reports can be generated. A system engineer could produce a report setting forth only customer-relevant changes.

The system includes the ability to generate reference data to be used by the Table Editor and generates tabular representation of schema specifications to be used in the MS Word document building process. The input to the module is an XML schema file. This module uses XSLT to transform schemas into tables retaining all of the necessary information. It also uses XSLT to generate reference data to be used by the Table Editor. The outputs of the module are files containing tabular representation of XML schema and XML files containing lists. The preferred embodiment of this element of the present invention was implemented using Java 1.4, Xerces 2.4 and Xalan 2.4.1

The above-described embodiment of the rule editor is used as follows. A user starts the tool. The user manipulates the Windows Common Dialog Box to navigate through directories, and eventually to choose a file to edit. The MSXML parser loads the file and parses the file and validates it against the internal file formats (i.e., the schema). The XML data is then transformed into XHTML using an XSLT stylesheet processor (part of MSXML). Two transforms are done. The first generates data from XML to displayable XHTML, a format that can be distributed to customers. The second transform adds annotations to every XHTML entry so the editor can locate them and adds special-purpose links in the left-hand column for editor functionality. The XHTML data is written to a file and is loaded by the web browser. Although the XHTML data is stored to disk it should be considered transient data because it is only used for the display, is rewritten with every change, and is deleted when the file is closed. The browser allows the user to scroll, search and otherwise navigate.

Locating an entry to be changed, the user indicates that he or she would like to edit the entry by clicking on the data item. VisualBasic code finds the XML representation of the data that was selected, copies the data from the XML representation to its own edit controls, and displays an appropriate edit form. The user makes a variety of changes using the controls on the edit form. The user accepts the changes by clicking the OK button.

VisualBasic code validates the entries (to the extent possible) in the controls on the edit form. If errors are found, a dialog box is presented to the user. This process repeats until the input is acceptable or the user cancels out of the box. Once the contents of the edit controls are considered valid, Visual Basic code copies the data out of the edit controls and converts it back into HTML using XSLT. The web browser view is refreshed so that the changes appear. The user requests that the changes be saved. The MSXML component stores the appropriate file in XML and the program exits.

The WordHelper tool is a tool to enable the use of the tables created with the structured editor into standard text-based documents such as those created using Microsoft Word software. The WordHelper tool operates in the following manner. A user starts the tool. A user manipulates the Windows Common Dialog Box to navigate through directories, etc. and eventually to open a “reference” word document for edit. The user uses the Visual Basic controls to insert references to business rule table files in the reference document. The user uses the Visual Basic controls to request the creation of a “deliverable” word document. A list of all table files referenced is compiled and a file list is generated on the user's computer. The table editor is invoked on the command line passing the file list file as a parameter. The table editor converts each of the tables files into html and places them in a temp directory with the locations written back to the XML file. If batch HTML conversion is successful, the Word Helper saves the reference document as a deliverable document. The Word Helper receives control of the application and iteratively inserts each of the HTML files into the deliverable word document. Any formatting the user has requested of the tool such as “insert in landscape mode” “rebuild table of contents” is also done. The Word Helper locks the document, preventing users from changing data within the tables and the deliverable document if saved to disk.

Each interface specification file contains the following elements. Element “strideTable” is the top-level element and contains everything. Attributes of this element include the version of the schema that last parsed this file (schemaVersion), and the version of the editor that created this file (editorVersion). The “tableSpec” element contains the layout of the table thereby defining how a table is structured. It includes a table's heading, context, table type and the column's structures. The “columnSpc” element defines a column including a column's heading, content type, data mapping, any validation (validValues) or cross-referencing to other files; The “tableData” element includes the data portion of the table and contains dataRows containing dataCells. The “dataCell” element is an individual cell of data. The structure of the data is dependent on the content type of the column. The data structure can be a single simple Text element, or a complex structure containing rules.

A file created using the present editor may contain a rule element. A rule consists of a condition to be tested and an action to be taken if the condition is true (basic if-then statement). Rule sequences are used in validation rules. A rule consists of the following ordered sequence of elements: label, selector, condition, action or rules, notes, and user requirements (userreqs). The label is a required element that is intended to support requirements traceability and is a free-text entry. The selector controls whether the rule is selected for evaluation and is selected from the group of: “if”, “else”, “if not” or “otherwise.” The condition is a list of expressions to be evaluated. Every validation rule must have a condition. Action is an element that specifies the action to be taken if the expression evaluates to be true. The Rules element is an element with a list of rules. This creates a nested rule. The editor will only allow the user to enter one level of nesting, so a data file will never have rules nested more than two deep (outer and inner).

The notes element is an optional element with a free text description of the rule. The userreqs element is an optional element containing a list of User Requirements numbers that are satisfied by this rule and is used for traceability.

The condition in a rule is built as an expressions element. The expressions element is an unbounded list of expression and expressions elements. The expressions element has an attribute connector which is where the “and” or “or” is stored that links the expressions in the list. In keeping with the convention of parse trees, expression lists that use both “and” and “or” connectors are stored such that all expressions in an expressions element are linked with the same connector. The expression element captures a single Boolean expression and consists of the following ordered sequence of elements: field, test, and one of rvalue (a single value), rrange (a value range), rlist ( a list of values) or rfield (a qualified field name). The field element is the name of the field, either simple or qualified, that is being used in the condition. The test element is the test being applied to the field or field value such as “is.” Other tests are also possible.

An action element that appears in a rule is chosen from the following elements: error, placeholder, presence, edit flow, or custom. The error element specifies an error code and message is to be returned. The placeholder element is a string that equates to “removed.” This element supports requirements traceability in the event that a rule is deleted it keeps the label alive. The presence element is a string that specifies whether an entry must be present or not. The edit flow is an instruction to the processor that editing should stop at the flow or form level. Optionally processing can resume at the next form if this is the last entity in a form. Custom is a free-text string that allows the user to record an action that cannot otherwise be specified with the tool until such a time as that action can be added to the tool.

The qualified name element is an element containing a list of statements that allow a fairly complex specification of some data. It is a substitute for the ability to chain function calls such as f(g(a)). A list of known qualifiers exists in a configuration file read when the process is initiated. The number of parameters and how each qualifier should be rendered is stored in a configuration file that controls how information is displayed. The qualifiedname element consists of the following ordered sequence of elements, qualifier and qualifiervalue. The qualifier element is a string such as “Occurrence” or “Length”. Essentially the name of the function to be called. The element qualifiervalue is an optional element that is essentially an argument for the qualifier appearing 0-n many times. It is usually the name of a field, a value such as “1”, a known qualifier parameter, such as “alphanumeric” or another qualifedname element.

Table context defines the scope of the table. A form level table specifies business rules for any number of fields within a particular form. A field level table specifies business rules for one particular field. A field column should not be needed in this table because the table context is already specified as a specific field. Business rule and condition columns will use the table-wide field context if there is no field column. An XPath level table context specifies business rules for a particular field that may occur in several forms.

Table-wide conditions are conditions that appear at the top of a document. This is a condition, not a validation (no action), whose purpose is to further constrain the scope of the table. Free text conditions override the structured condition editor with free-text input. This is invoked through the use of the checkbox at the bottom right side of the condition editor control. It is used when you do not know how to structure the condition or the editor lacks a predicate to structure the condition. Overrides will hinder the use of automated generation of the transformation and validation software.

Validation references must come either from known enumerations or table files that contain a definition column.

The system can be used for transferring existing word processor formatted requirements documents to the message definition and rule tables of the present invention. This adoption procedure provides requirements engineers with an option to transition to the new process incrementally. A converter module translates business rules form MS Word format to the target XML format. A special-purpose parser identifies constructs that cannot be parsed and the requirements engineer is then responsible for modifying the document to eliminate common error and ambiguities. Once the document has been cleaned of unparseable the converter tool produces an XML representation of the original MS Word data. During the conversion, a significant amount of data redundancy is eliminated. As an added benefit, labels that enable requirements traceability are supplied automatically. Any remaining unparseable segments are identified and clearly marked as such in the XML file. These segments must later be rewritten to a structured formatted using the XML editing tool.

The conversion/migration process is iterative. A requirements engineer first converts the current documentation into a Microsoft WORD document and submits the document for parsing. In return, a list of error messages is displayed to guide the requirements engineer to entries requiring additional rewrites. Second, if necessary, extensions are made to the parser's grammar, the guidelines mentioned above, and the underlying XML schema so that as many constructs as possible can be parsed. Third, the requirements engineer resubmits the document for parsing. The process is repeated until an acceptable pass rate is achieved, preferably between 86 and 100 percent.

Certain variations are handled in different ways. In certain cases, different syntactical expressions are accommodated with the same semantics. For example, requirements engineers refer to the contents of the current ILEC element as “data” “data in this field” “this field” “values” or the element name itself. The parser has been designed to handle all these variations and then eliminate the redundancies by translating them into a single reference to the current ILEC element. Other variations are either too seldom used to warrant automatic conversion or are too ambiguous to convert without human intervention.

FIG. It depicts a functional overview of the various elements of the present system including the specification of data types 1115 and data modeling 1100 that are used to develop the underlying message schema 1125. These elements along with the business rule table schema and metadata 1135 help define the business rule specification 1110 input by the requirements engineer. This business rule specification is used to generate the above identified XML based business rule tables 1145 which are then used as part of code generation 1130 along with the business rule table schema and metadata 1135 to generate the validation and transformation code 1165. Business rule table schema and metadata are also used as part of message test generation 1120 along with the business rule tables 1145 to develop a set of test cases 1155. The business rule 1145 tables are also used as part of document generation 1140 to generate word processing formatted documents 1175 for use by the requirements engineers and other users.

Once the message transformation code and the message validation code has been generated by code generator 330, a wireless number portability system would work in the following manner. A port request written in XML would be received in the message processing engine. The port request is then subjected to the transformation rules for transforming a port request into the message format desired by the trading partner. The transformed port request would then be subjected to validation rules in the message processing engine. The transformed and validated message may now be forwarded to the trading partner. If the message contains errors that are identified by the validation rules then it is returned to the originator of the message for additional processing, i.e., error correction. The XML business rule file is input, i.e., opened by the code generation system. The business rule file header information is processed. Each element or group of elements in the file is processed as follows. In the preferred embodiment, appropriate W3C XML Schema constructs are generated for occurrence constraints, parent-child relationships, length constraints; content-type constraints; data format constraints, and valid-value constraints. The code generation system additionally generates XPath expressions to test any cross-element constraints that are entered as rules in the file; the corresponding error messages from the business rule file are transferred to the implementation. At runtime, a validating XML parser checks these constraints and return an appropriate error message if they are violated. Subsequently an XSLT processor runs the Xpath expressions to check all cross-element constraints. In an alternative embodiment, only Xpath expressions are emitted (no Schema). To validate all constraints on element in this embodiment, the code generation system generates only XPath expressions. These XPath expressions determine whether any child elements of a group of elements are either conditionally or unconditionally required, whether a group in the Test Message appears too many or too few times, whether an element length is appropriate, etc. The code generation system also generates an error message that will be produced at run-time if the constraints are violated, or uses the error message specified in the rules file, as appropriate. The error message will be produced at run-time if any of the specified conditions are true.

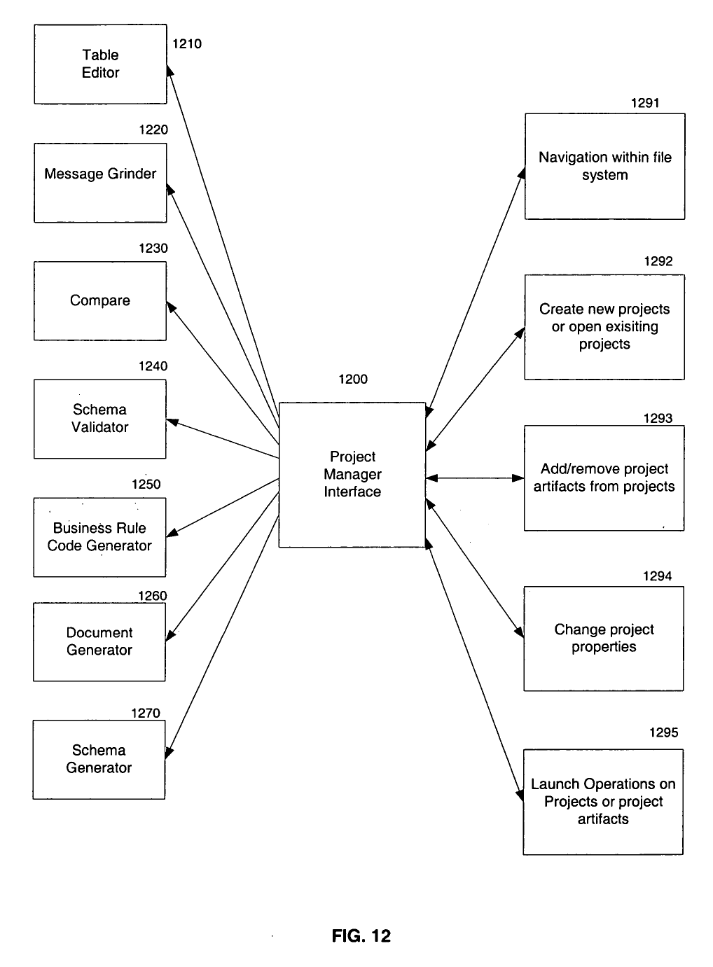

FIG. 12 depicts the detailed architecture for the project manager that combines elements of the present invention into one user interface for manipulation of files for the generation of schema, transformation and business rule validation code. The project manager interface 1200 provides the user with a central location for performing the tasks depicted as functional elements 1291-1295. Project manager interface 1200 provides a graphical user interface for navigation within the file system and arranges all files related to a project in a window accessible to the user. Project manager interface 1200 enables the user to create new projects or open existing projects and enables the user to change project properties including the addition or removal of project artifacts from projects. Projects are referred to by a “Project Root” which is a location in the directory hierarchy where all files for a project are stored for sharing purposes. The project manager interface displays each structured table that is party of a project, including any Data Dictionary entries and Message Definition entries for a project. The interface also enables the user to define one or more “USES” files which define certain elements of the project that are not to be changed, i.e., reference data or error codes.

The project manager interface 1200 enables the user to launch the software modules described below. The GUI implementing the project manager may be of any style provided that it enables the user to perform the functions described above.

The Table Editor 1210 enables the user/requirements engineer to input Message Definitions, Data Dictionary Entries and/or business rules as described above. The editor 1210 is a structured editor as described earlier that constrains the input of the user in order to minimize errors and invalid types etc when inputting business rules. The table editor supports the creation of the following project artifacts: Business Rules, Business Grids, Data Dictionary, Message Definition, Error Definitions, Generic, Trace Matrix, User Requirements and Variable Definition.

The Table Editor 1210 performs validation of user input when creating business rule tables by doing data cell and cross column validation. It does not check to see that there is any inconsistency across all files. The Table Editor ensures that all stored conditions are well formed and that all values specified as fields in a business rule table file are present in the list of known field values. A table has columns of one or more of the following contents: Field, Field List, Condition, Business Rule, 1-D Logic Gate, 2-D Logic Gate, Definition, Simple Condition, Requirement ID, Requirement Text, Error Code, Error Text, Notes, File Name, Other, Type Name, Full Name, Description, Data Type, Pattern, Length, CodeSet, Range, Directive, Element Name, Element Type, Occurrence, Variable Reference and Requirement List. For example, a Data Dictionary table contains at least Type Name, Description, DataType, Pattern, Length, CodeSet and Range columns.

The Table Editor 1210 enables the user to create Message Definition tables that have five default columns: Directive, Element Name, Element Type, Occurrence and Description.

The Table Editor 1210 also enables input of Business Rule Tables that enable input of “if-condition-then-action” rules. Nested rules are permitted in the preferred embodiment of the present invention up to one level of nesting. Test selectors include “if”, “else if”, “else” and “if not.” Business Rule Tables are discussed in detail above. Business grid tables in one and two dimensions are used to more succinctly express conditions for a field.

Error Tables define a set of error messages and consist of at least two columns: type error code and type error text. These are then used by the Business Rule Tables when the action to be taken relates to an error code. User Requirements Tables define a set of user requirements referenced in business rules and traceability documents. User Requirements Tables require a header and two columns: requirement ID and requirement text.

Variable Definition Tables define a user specified enumeration and corresponding valid values. Variable Definition Tables are referenced wherever known enumerations are accepted as input. Variable Definition Tables consist of a header and at least a single definition column. Variable Definition Tables may also be used to associate the values of the user-defined enumeration to act as shorthand for a condition. In such case, the Variable Definition Table must include both a definition columns and a condition column. If a condition is present, the entry in the condition must be associated with the corresponding definition column and the enumeration will correspond to the condition stated.

Requirements Trace Matrices map user requirements to the system requirements that satisfy them. These tables are generated automatically by analysis of Business Rule Tables and User Requirements Documents. A Requirements Trace Matrix consists of a header and, minimally, three columns: requirements ID, requirements list and requirements text.

A SchemaGenerator 1270 accepts instances of the Data Dictionaries and Message Definitions and produces W3C compliant XML schemas. The tabular interface specifications are converted into XML representations for input to the Schema Generator. The Schema Generator enables certain constraints to be enforced on the schema to be generated. For example, if it is known that the schema are to be used in a specific environment, e.g., Castor, that does not accept certain schema constructs, then prior to generation, the user can select from one or more constraints in order to insure downstream compatibility with specific software. For example, is it is known that the downstream software that is going to implement the schema does not accept nesting then the user may select to restrict the output of the Schema Generator 1270 to contain no nesting.

Once the schemas for a product interface have been generated, they should be validated using Schema Validator 1240 to check for any undefined group of elements or elements. In a current preferred embodiment of the present invention, the Schema Validator is the Xerces2 JavaParser. The IBM® AlphaWorks-XML Schema Quality Checker may also be employed for this purpose.

Business Rule Code Generator 1250 generates software/code to validate the business rules created using the Table Editor 1210 as discussed in further detail above.

Message Grinder 1220 is a software module that automatically generates test cases t 6 test the message definitions and business rules in order to determine if there are any problems with them. The Message Grinder also reports all malformed business rules that it encounters in a business rule file, i.e., a Business Rule Table.

Compare tool 1230 can be used to compare projects, i.e., whether the elements of one project different from the elements of another project. The tool may also be used as a schema comparison tool described above to compare two schemas and identify differences between the schemas. Tables within a document can be compared against a previous version of a document.

Document Generator 1260 provides a derived view of the Message Definition, Data Dictionary or business rule tables in rich text format (RTF). This format can then be imported by the requirements engineer into word processor compatible files, e.g. Frame files. RTF files can be used in cases where the document tables that drive the process are not expressed in standard form. The standard tables produced along with the schemas can be inserted into the requirements documents from which they have been derived, providing the documents with a standard base against which future versions can be produced. The Document Generator also supports editing document templates and final documents. Word Helper, discussed above, can be used within document generator in order to produce desired documentation for the user. The Document Generator 1260 also enables the user to perform Prune and index functions. The prune function enables the user to prune unused elements, i.e., elements not currently used by a project, from a Data Dictionary in order to make the Data Dictionary easier to use. The output of the pruner is another albeit smaller Data Dictionary containing entries for used elements. The index function generates an index table listing each element used in a project and where the element is used. The index function may be used to highlight new elements that are not yet defined in a Data Dictionary and to provide the user of an overview of similar elements and their uses. The columns of the index table are “Row”, “TypeName” “Element Group/Element” “Qualified Type Name” “Message Definition Where Used” and “Path within Message Definition.”

An additional tool (not shown in FIG. 12), the MultiParser tool enables the user to parse existing interface requirements documents, extract the necessary information, and compose the standard interface definitions. This utility has a set of predefined format stereotypes based on the different documentation styles we encountered in the requirements. These stereotypes are designed as plug-ins and can easily be modified to add new styles. The MultiParser tool is driven from a configuration file that identifies the bundle of interface components, the specific stereotype matching the interface requirements style, and additional contact information such as the naming scope. The non-standard interface source files are parsed and transformed to the normalized interface definition, which are then processed by the SchemaGenerator to generate XML schemas (XSDs).

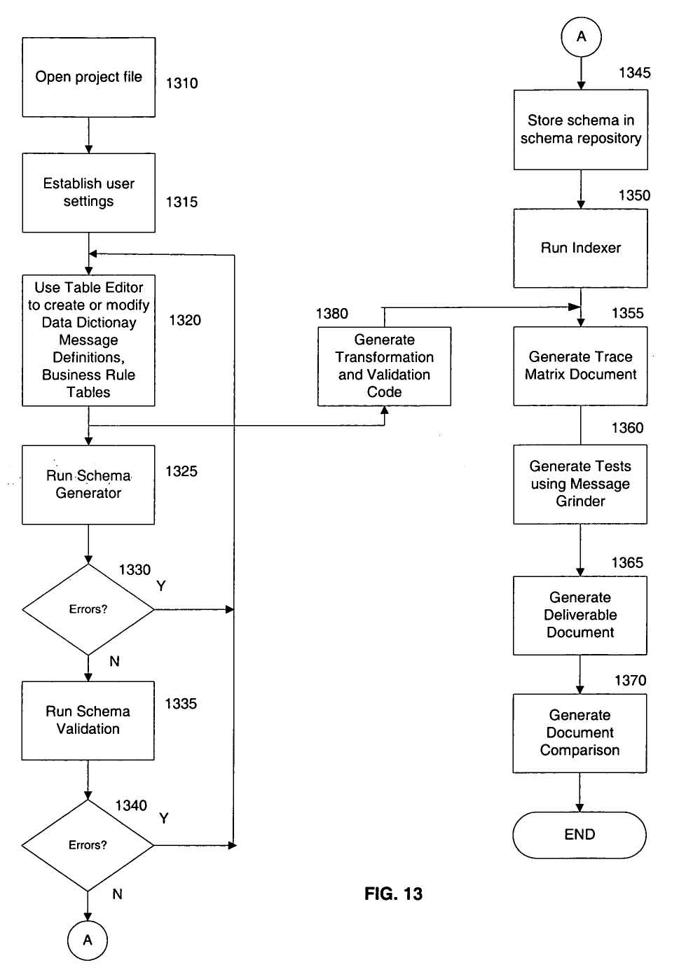

FIG. 13 depicts the process flow for the implementation of the present invention where external reference schemas (message definitions) are not used. At step 1310 the user opens a project file that, as described above, contains all of the elements necessary to define a project. At step 1315, the user specifies certain user settings such as specifying reference data sources such as pointers to Variable Definition Tables, User Requirements Tables, lists of message field names and well-known value sets which are read from structured tables. At step 1320 the structured table editor is used to create or modify Data Dictionary Tables, Message Definition Tables and Business Rule Tables. At step 1325 the Schema Generator is executed using these tables as inputs. If errors are identified at step 1330 the user returns to step 1320 to use the Table Editor to modify the tables so as to remove the identified errors. If no errors are identified as a result of schema generation then the Schema Validator is run at step 1335. If errors are detected at step 1340 the user is redirected to step 1320 where the Table Editor is used to correct any identified problems. If no errors are identified then the schema are stored in the repository at step 1345. At step 1350 the indexer tool is run. At step 1355 the trace matrix document is generated. At step 1360 tests are generated using the Message Grinder and at step 1365 a deliverable document is generated. At step 1370 a document comparison is generated and the process ends.

Simultaneously to steps 1325 through 1350 described above, the code generator generates the transformation and validation code at step 1380 using the business rules input at step 1320.

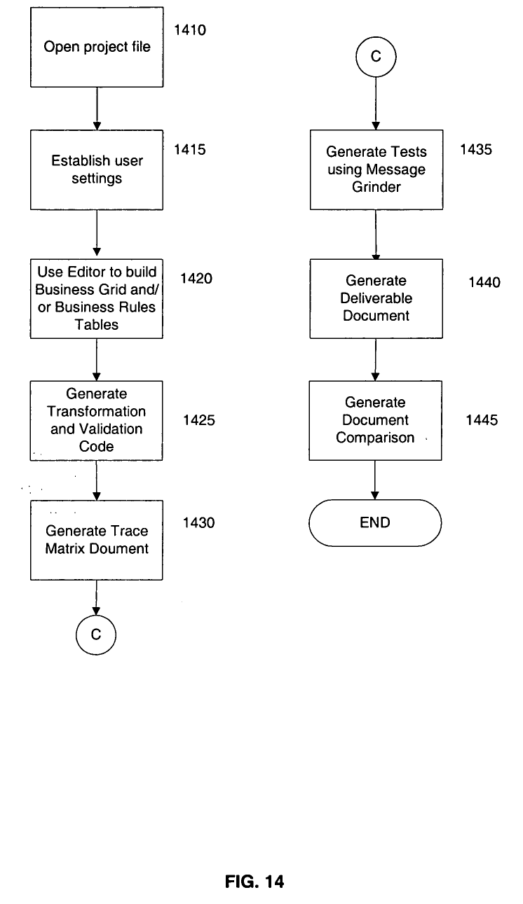

FIG. 14 depicts the process flow for the implementation of the present invention where external reference schemas are used, i.e., messages are not defined in the system. At step 1410 the user opens a project file that, as described above, contains all of the elements necessary to define a project. At step 1415, the user specified certain user settings such as specifying reference data sources such as pointers to Variable Definition Tables, User Requirements Tables, lists of message field names and well-known value sets which are read from structured tables. At step 1420 the structured table editor is used to create Business Rule Tables possibly including Business Rule Grids. At step 1425 transformation and validation code is generated. At step 1430 the trace matrix document is generated. At step 1435 the Message Grinder is used to generate tests. At step 1440 a deliverable document is generated. At step 1445 a document comparison is generated and the process ends.

The above description has been presented only to illustrate and describe the invention. It is not intended to be exhaustive or to limit the invention to any precise form disclosed. Many modifications and variations are possible in light of the above teaching. The applications described were chosen and described in order to best explain the principles of the invention and its practical application to enable others skilled in the art to best utilize the invention on various applications and with various modifications as are suited to the particular use contemplated.

1. A method for the automatic generation of message validation and/or transformation software from message interface specifications and business rules for use in a message processing system comprising the steps of:
inputting a set of message definitions, data dictionary entries and/or business rules using a structured editor to create a set of structured files that define the message interface and/or business rules;
generating message validation software from the set of structured files;
storing the message validation and transformation software in one or more databases for use by the message processing system.

2. The method of claim 1 wherein the set of message definitions and data dictionary entries can be reused to develop additional message definitions, dictionary entries and/or business rules across an enterprise.

3. The method of claim 1 further comprising the step of generating message transformation software from the set of structured files.

4. The method of claims 2 or 3 wherein the structured files are in the XML format.

5. The method of claim 4 wherein the generation of message transformation software and message validation software further comprises the step of translating the structured files in the XML format into Extensible Stylesheet Language Transforms (XSLT).

6. The method of claim 1 wherein the step of generating message validation software further comprises the step of inputting the structured files into a schema generator in order to generate a set of W3C XML Schema to be used to validate messages.

7. The method of claim 1 wherein the step of inputting further comprises the step of validating the structured files to ensure the structured files conform to a pre-determined structure.

8. The method of claim 1 wherein the structured editor provides a graphical user interface to the requirements engineer for editing the structured files in a tabular format.

9. The method of claim 1 wherein the structured files are presented to the user in HTML.

10. The method of claim 9 wherein the structured rule editor uses a web browser to present the HTML to the user.

11. The method of claim 1 further comprising the step of producing a report detailing differences between two sets of structured files.

12. The method of claim 6 further comprising the step of modifying the structured files after generating the XML schema in order to correct errors identified by the schema generator.

13. The method of claim 6 further comprising the step of inputting the set of interface schemas into a schema validator to determine if the generated schemas are correctly formatted and consistent.

14. The method of claim 13 further comprising the step of modifying the structured files after validating the schema in order to correct errors identified by the schema validator.

15. The method of claim 1 further comprising the step of transferring pre-existing word processing formatted business rule documents into structured files.

16. The method of claim 6 further comprising the step of importing from existing W 3 C XML Schema files into a set of structured files.

17. The method of claim 15 further comprising the steps of:
translating the word processing formatted document into an XML formatted document;
parsing the XML formatted document to identify unparseable constructs and errors;
presenting the unparseable constructs and errors to the requirements engineer for modification;
rewriting the unparseable constructs into a structured construct using the structured rule editor; and,
repeating the parsing, presenting and rewriting steps until all unparseable constructs and errors are substantially eliminated.

18. The method of claim 1 further comprising the step of generating a set of test cases to provide test messages with which to test the message transformation and message validation software.

19. A system for the automatic generation of message validation software and/or transformation software from business rules for use in a message processing system comprising:
a structured editor for inputting a set of message definitions, data dictionary entries and business rules to form a set of structured files that defines the message interface as a set of nested elements and groups of elements and business rules;
means for generating message validation software from the structured files;
storage means for storing the message validation and transformation software in one or more databases for use by the message processing system.

20. The system of claim 19 further comprising the means for generating message transformation software from the structured files.

21. The system of claim 19 wherein the set of message definitions and data dictionary entries can be reused to develop additional message definitions, dictionary entries and/or business rules across an enterprise.

22. The system of claim 19 wherein the means for generating the schema inputs to message validation software from the structured files is an XML schema generator.

23. The system of claim 19 or 20 wherein the means for generating message transformation software and message validation software further comprises a means for translating the structured files in the XML format into Extensible Stylesheet Language Transforms (XSLT).

24. The system of claim 19 wherein the structured editor comprises a means for constraining the inputs into the structured files to ensure the structured files conform to a pre-determined structure and content.

25. The system of claim 19 wherein the structured editor comprises a graphical user interface for editing the structured files in a tabular non-XML format.

26. The system of claim 24 wherein the structured editor limits the selection of attributes available to a user during definition of an element, group of elements or rule.

27. The system of claim 19 further comprising means for generating an index listing of all elements used in an interface definition, cross referencing entries within data dictionaries with their appearances within message definitions.

28. The system of claim 19 further comprising a means for pruning a data dictionary into a data dictionary that comprises only those elements and/or group of elements that are used in a message interface definition.

29. The system of claim 19 further comprising a project interface for providing access to the user of all structured files used to define the project and access to all functions that can be performed on such files.

30. The system of claim 19 wherein the structured editor is a table editor which enables the user to input tables selected from the group consisting of: Message Definition Tables, Data Dictionary Tables, Business Rule Tables, Error Tables, Variable Definition Tables, and Requirements Trace Matrix Tables.

31. The system of claim 19 further comprising a document generator for generating user-readable documentation specifying the message definition interface and business rules.

32. The system of claim 19 further comprising a compare tool for comparing a first structured file or document with a second structured file or document in order to develop a list of differences between such files or documents.
